(19) United States
(12) Patent Application Publication
(10) Pub. No.: US 2006/0053914 A1
(43) Pub. Date: Mar. 16, 2006

(54) Transmission assembly

(75) Inventor: Heinz-Josef Hautvast, Brigachtal (DE)

Correspondence Address: SIEMENS SCHWEIZ;I-44, INTELLECTUAL PROPERTY, ALBISRIEDERSTRASSE 245, ZURICH, CH-8047, CH

(73) Assignee: Siemens Aktiengesellshaft, Munich (DE)

(21) Appl. No.: 10/536,034

(22) PCT Filed: Nov. 10, 2003
(86) PCT No.: PCT/DE03/03719

§ 371 Date: May 23, 2005

(30) Foreign Application Priority Data
Dec. 4, 2002 (DE) 102 56 717.4

(51) Int. Cl. F16H 27/02

(52) U.S. Cl. 74/89.11

(57) ABSTRACT

The invention relates to a transmission assembly comprising a toothed rack (1) and a gear (2) that is linked with a shaft (4) constituting a control cam and that engages with the toothed rack (1). The inventive transmission assembly is characterized in that a stop (5) is provided on the toothed rack (1) and interacts with a projection (6) of the gear (2) or with the shaft (4). The inventive stop substantially simplifies installation of the transmission assembly.

The invention relates to a transmission assembly with a rack and with a gearwheel which is connected to a shaft forming a control cam and which engages into the rack.

Such transmission assemblies are used in many diverse ways in precision-mechanical instruments in which mechanical sequences are controlled cyclically. In the case of tachographs, for example, it is necessary to control the raising and lowering of a recording stylus which is used for various recording tasks. In the normally manual assembling of the instruments, the rack, on the one hand, and the gearwheel, on the other hand, are inserted one into the other, and the two parts have to be joined together in a specific position so that the control cam can correctly perform its controlling task.

For this purpose, it is known to provide both the rack and the gearwheel with a marking, so that the person carrying out the assembling can orient the rack and the gearwheel exactly with one another. For reasons of cost, as a rule, a colored marking is not used in this case, but, instead, an appropriate surface structure serving as marking is applied during the production of the rack and the gearwheel which are usually plastic injection moldings.

With advancing miniaturization, it is increasingly more difficult, during assembly, to join the rack and the gearwheel together in the exact position. Wrongly placed parts are often detected only during the final check, so that a considerable outlay is required in order to correct the position of the rack and gearwheel. Wrongly assembled transmission parts therefore give rise to high costs either due to an increased rejection rate or because of the subsequent elimination of faults.

The object of the invention is, therefore, to specify a transmission assembly which ensures that the rack and the gearwheel are joined together in the correct position.

This object is achieved, according to the invention, by means of a transmission assembly of the type initially mentioned, which is characterized in that the rack has provided on it a stop which cooperates with a projection of the gearwheel or of the shaft.

By virtue of the stop according to the invention, it is no longer necessary to detect the coinciding of two markings visually, but, instead, in a specific position, there is only one assembly possibility. The advantage of the invention is that the transmission parts can be joined together, without markings difficult to recognize visually having to be taken into account.

In the design according to the invention of a transmission assembly, it is possible further to reduce the transmission parts, without assembly problems thereby arising. In particular, it is possible to reduce the rejection rate. Since the assembly step susceptible to error is simplified, the assembly time is shortened, without the rejection rate being increased as a result.

In the manufacture, preferably to be provided, of the transmission parts as plastic injection moldings, the production according to the invention of the projection and of the stop can be implemented without an additional cost outlay.

In an advantageous embodiment of the invention, a tooth of the gearwheel is designed in such a way that it forms a projection which can cooperate with the stop.

The invention is described in more detail below by means of an exemplary embodiment. In the drawing:

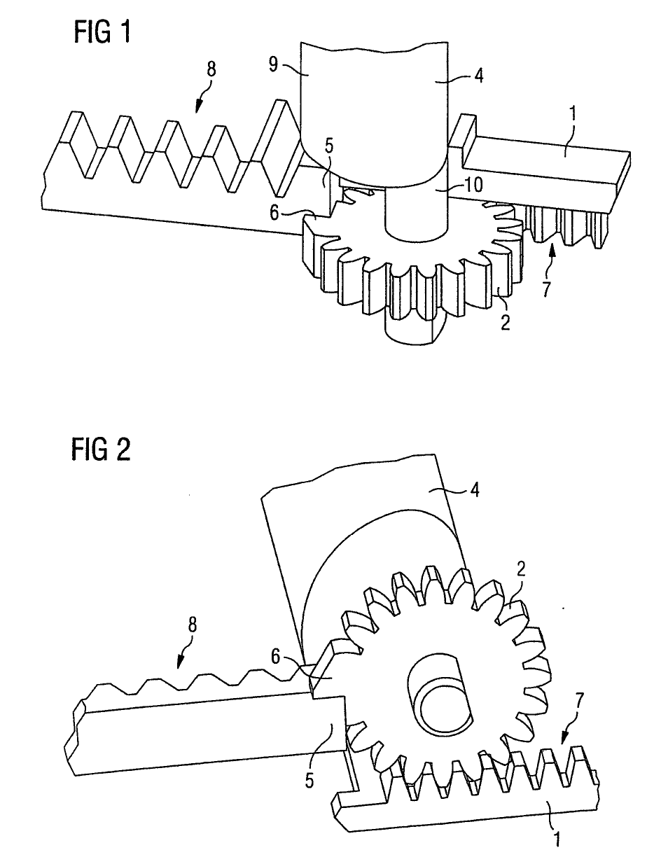

FIG. 1 shows a first three-dimensional view of a transmission assembly according to the invention, and

FIG. 2 shows a second three-dimensional view of a transmission assembly according to the invention.

The transmission assembly illustrated in FIG. 1 possesses a rack 1 which has two toothed regions 7 and 8. The toothing of a gearwheel 2 engages into the first toothed region 7. The gearwheel 2 is connected to a shaft 4, a first region 10 being connected to the gearwheel and a second region 9 forming a control cam. The axis of rotation of the gearwheel 2 runs through the shaft portion 10, while the portion 9 forming the control cam possesses an axis parallel to and spaced apart from the first axis. However, the control cam portion 9 does not have to possess a circular or oval shape, but, instead, the shape of the control cam portion 9 may be adapted to the corresponding control task.

The second toothed region 8 of the rack 1 may be used, for example, for driving the rack 1.

The gearwheel 2 possesses a projection 6 which is stamped out instead of one or of a plurality of normal teeth. In this exemplary embodiment, the projection 6 possesses the width of a plurality of normal teeth. The projection 6 cooperates with a stop 5 which is formed on the rack 1. When the rack 1 and the gearwheel 2 are assembled in an extreme position of the gearwheel with respect to the rack 1, the projection 6 is in contact with the stop 5. Assembly may take place, for example, in that, first, the projection 6 is brought into contact with the stop 5, thus subsequently ensuring that the toothing of the gearwheel 2 and of the rack 1 engage correctly one into the other.

After correct assembly, the two faces of the stop 5 and two faces of the projection 6 have to lie with a form fit against one another.

FIG. 2 shows a second three-dimensional view of the transmission assembly according to the invention of FIG. 1, the end face of the gearwheel 2 being visible in this perspective. In the version of FIGS. 1 and 2, it is possible only to cause the gearwheel to rotate through three quarters of a revolution, since the projection 8 thereafter no longer fits together with the toothing 7 of the rack 1. It would, at most, be possible to profile the rack 1 in such a way that the projection 6 can engage into a corresponding depression of the rack 1.

In other versions, however, it is also possible, instead of the projection 6 on the gearwheel 2, to provide a projection on the end face of the gearwheel 2 or on the shaft, in particular on its control cam portion or its end region. In such an embodiment, it would be substantially simpler to allow a multiple rotation of the gearwheel 2, without the projection impeding the rotation.

1. A transmission assembly, comprising
a rack comprising a stop, and
a gearwheel comprising a projection, the gearwheel connected to a shaft so as to form a control cam and engage the rack such that the stop,
cooperates with the projection or the shaft.

2. The assembly according to claim 1, wherein the projection is formed in the toothing of the gearwheel.

3. The transmission assembly according to claim 1, wherein the rack and the gearwheel are produced as plastic injection moldings.

4. A tachograph comprising:
a rack comprising a stop, and
a gearwheel comprising a projection, the gearwheel connected to a shaft so as to form a control cam and engage the rack such that the stop cooperates with the projection or the shaft, wherein the rack and gearwheel are arranged to control a reading stylus.
